(19) United States
(12) Patent Application Publication
(10) Pub. No.: US 2015/0223446 A1
(43) Pub. Date: Aug. 13, 2015

(54) INFLATABLE, STOWABLE AND PORTABLE ANIMAL DECOY

(71) Applicant: Christopher Vaaler, Bisbee, AZ (US)

(72) Inventor: Christopher Vaaler, Bisbee, AZ (US)

(21) Appl. No.: 14/549,302

(22) Filed: Nov. 20, 2014

Related U.S. Application Data
(60) Provisional application No. 61/963,034, filed on Nov. 21, 2013.

(51) Int. Cl. A01M 31/06; F16M 11/04; A01M 31/00

(52) U.S. Cl. CPC A01M 31/06; A01M 31/00; F16M 11/043

(57) ABSTRACT

There is provided a animal decoy which simulates real life motion and life like appearance through sewing and printing technique. Air driven motor fan that is battery operated by a remote control and power regulator to control air speed. By turning the unit on and off air enters and leaves the decoy which creates life like movements. A filter with scent is added to the fan intake to disperse scent of choice.

### FIELD OF INVENTION

The present invention relates to decoys and more particularly wild animal decoys and the method of use.

### BACKGROUND OF THE INVENTION

Decoys for hoofed wild animals such as deer, elk, antelope, etc. are commercially available in two or three dimensional forms. The two dimensional decoy mounts are typically made of a two sided photographic images of the animal supported by a flat panel surface such as a wood, plastic, etc. panel having sections which fold together. The three dimensional decoys are molded and fabricated of a rigid material. Consequently these three dimensional decoys are bulky and not easily stowable for transport.

There exists a need for a stowable and easily transportable decoy which may be readily assembled at the hunting site and disassembled for transport after the hunt. It would also be of particular value if there existed a collapsible decoy equipped to disseminate an attractive prey scent. Similarly it would be desirable if the decoy were equipped with movable decoying parts adapted to attract the attention of the prey. These and other benefits and advantages are fulfilled by providing of a continuous ambient air inflatable decoy adapted to be readily assembled and disassembled at the hunting site.

### SUMMARY OF THE INVENTION

The present invention provides an inflatable and deflatable animal decoy which may be readily inflated and deflated at the hunting site. The decoy provides a stowable, portable, inflatable and deflatable three dimensional decoy powered by a battery driven inflation fan which provides the huntsman with a uniquely different decoy. The decoy provides significant advantages over the existing decoys. The decoy includes a battery operated D.C. motor which drives a pressurizing fan for inflating the decoy with air supplied from an ambient source. The decoy body is fabricated from a cover material having sufficient flexibility and durability to inflate to a formed decoy bearing a resemblance to a hunted prey while also allowing the decoy body to collapse into collapsible stowable form for ease of transport. The decoy is sufficiently pressurized and stabilized so as to maintain an uptight decoy standing position when inflated to a decoying position. The decoy may be fabricated with light weight and durable materials possessing sufficient flexibility to permit its stowing into a compact form for ease of toting from site to site so which enhances its efficacy for field use. The system used to inflate and maintain decoy inflation may be most suitably operated at a low decibel level so as to not spook the hunting prey. The inflatable decoy may include a prey scenting attachment released by the decoy during operational deployment of the inflated decoy.

### BRIEF DESCRIPTION OF THE PHOTOGRAPHS AND DRAWINGS

FIG. 1 is a side view depicting the inflated animal decoy of this invention.

FIG. 2 is a top view of the decoy shown in FIG. 1.

FIG. 3 is a frontal view of FIG. 1.

FIG. 4 is the top view of FIG. 1 marked with numbers to show patterned section placements.

FIG. 5 is a partial segment view depicting the marked sewing sections There within.

FIG. 6 is a partial top side view of FIG. 2 showing the positioning of the patterned sections sewn thereto.

Photograph 6 is the colored sewn pieces of decoy there within

FIGS. 7 and 8 are respectively enlarged rear and front views of the head shown in FIG. 1.

FIGS. 9A & 9B depict patterned piece section views bearing enumerations corresponding to the enumerations or numbering shown in the sewn pattern sections depicted in FIG. 4-8.

FIG. 10 is a view of the inflated decoy shown in FIG. 1.

FIG. 11 depicts a view of the decoy of FIG. 1 in a deflated form.

FIG. 12A depicts the decoy shown in FIG. 11 in a stowable and easily transportable condition.

FIG. 12B depicts placing the stowable decoy of FIG. 12A in a tote bag.

FIG. 13 shows a partial view of a supportive brace useful in inflating and maintaining an upright position of the decoy as shown in FIGS. 1-4 and 10.

FIG. 14 is a drawing depicting: the remote motor control system and power supply system used to inflate the decoy a; shown in FIGS. 1-4 and 10.

FIG. 15 is a partial frontal view of FIG. 14.

FIG. 16 depicts a flush mounted air intake of the decoy belly with a remote controlled power cable providing battery power to an internally disposed fan.

FIG. 17 is a close-up drawning of an internally housed fan having a motor driven by art external battery power source and a scent emitting source.

FIG. 17 A is an opposite side view of FIG. 17.

FIG. 18 depicts in more detail an air exiting scent emitting source shown in FIG. 17.

FIG. 19 is an internal view of an inflating decoy leg revealing a restricted airway which allows the inflating leg to inflate more readily than other sections of the decoy which assists in allowing the decoy to inflate in a more appropriate inflated position.

FIGS. 20A & 20B depict another brace support for maintaining the decoy of FIGS. 1-4 and 10 in an appropriate inflating position.

FIG. 21 depicts another type of brace support.

FIG. 24 shows decoy unit deployed on its side with components

FIG. 22 is a schematic drawing for a remote controlled audio calling system.

### DISCLOSURE OF THE INVENTION

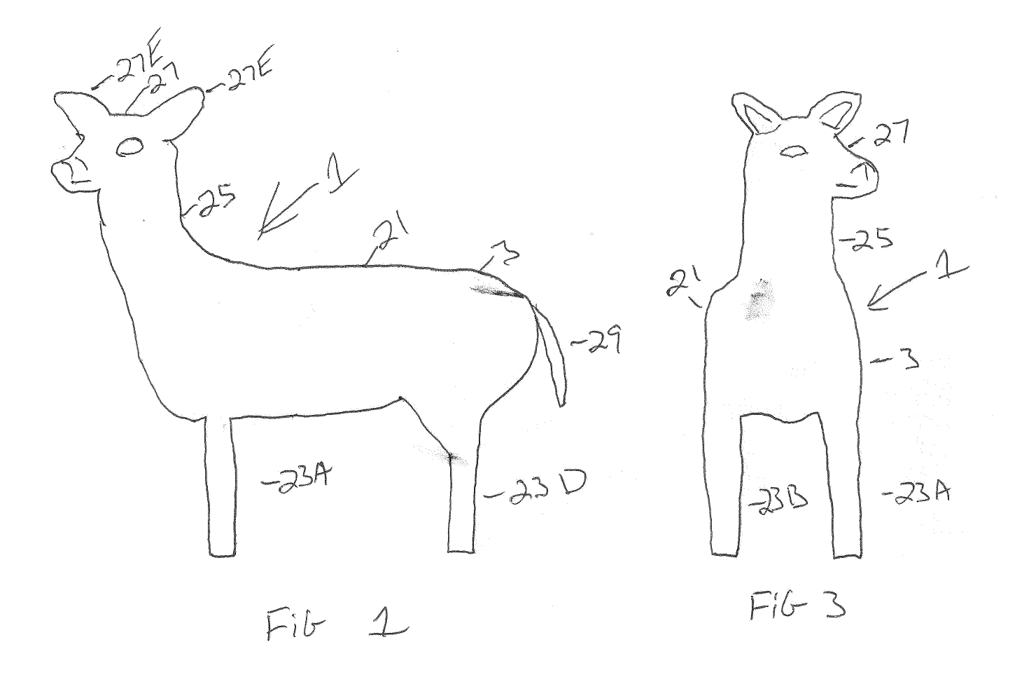

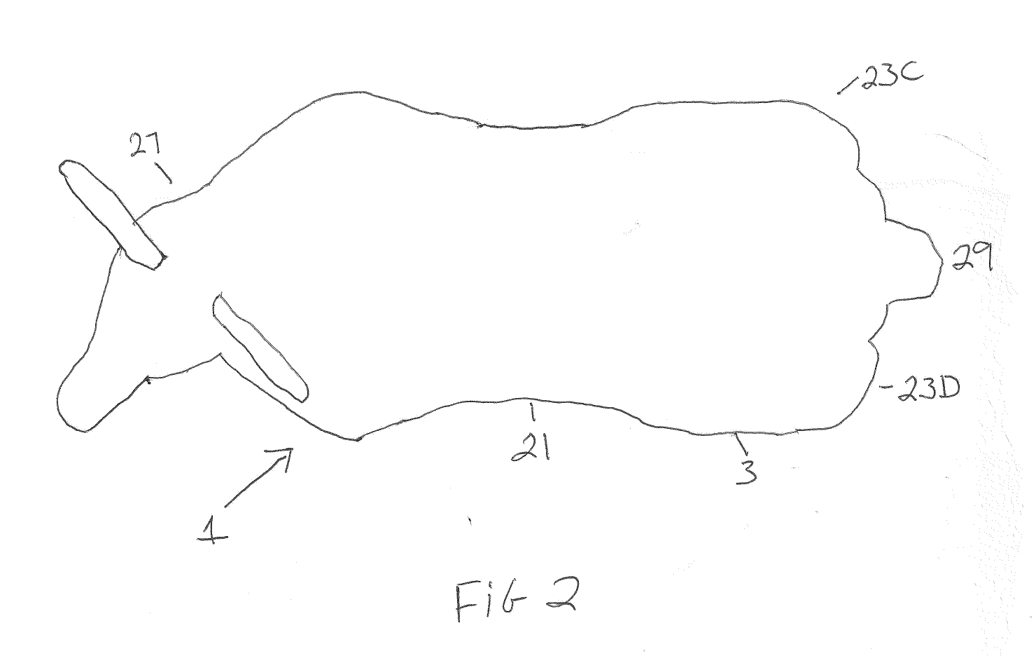

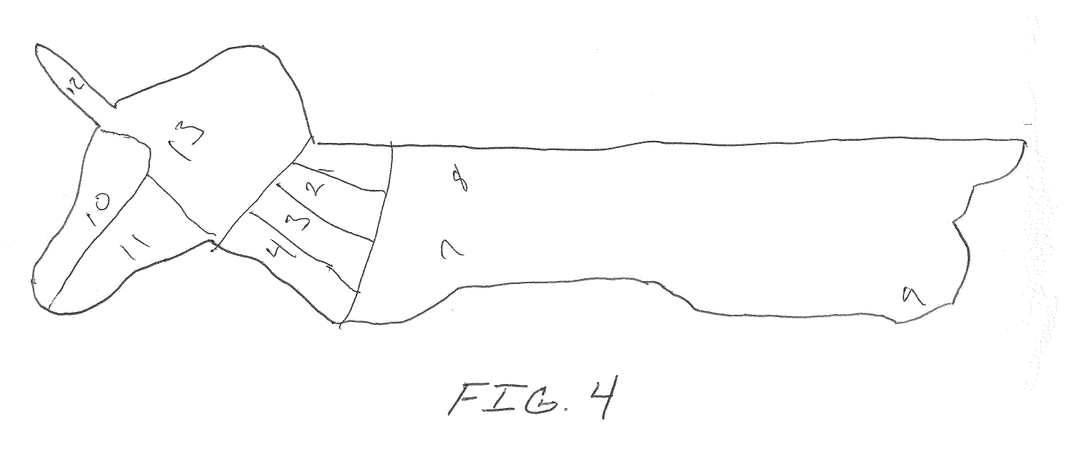

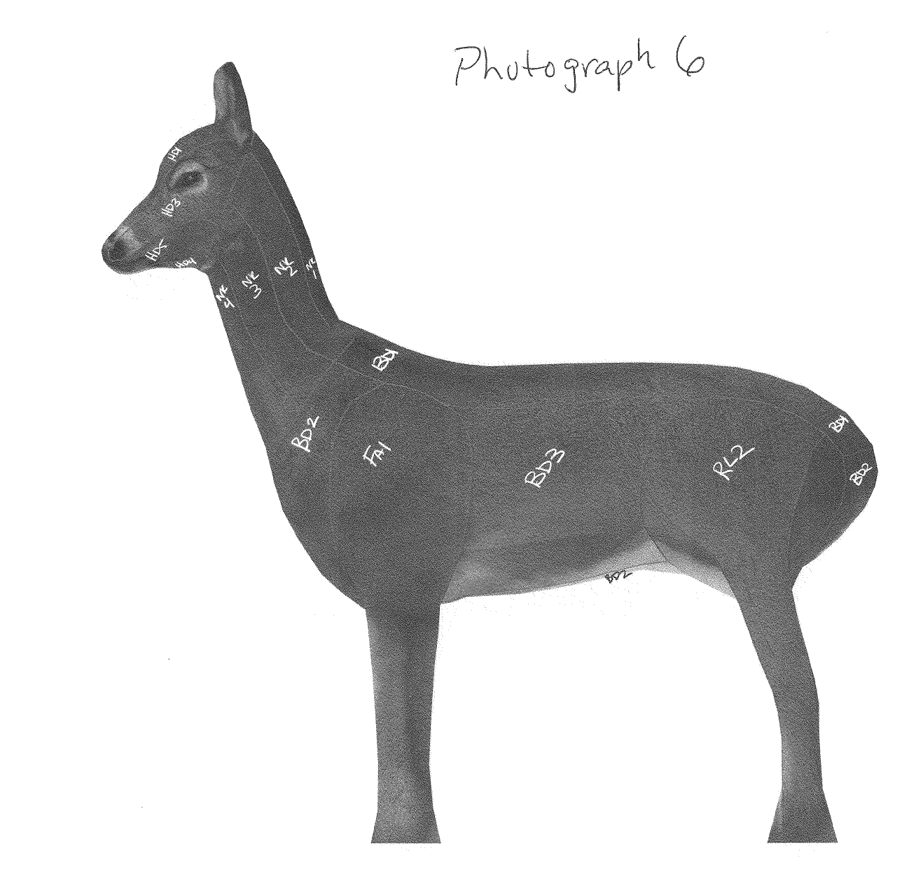

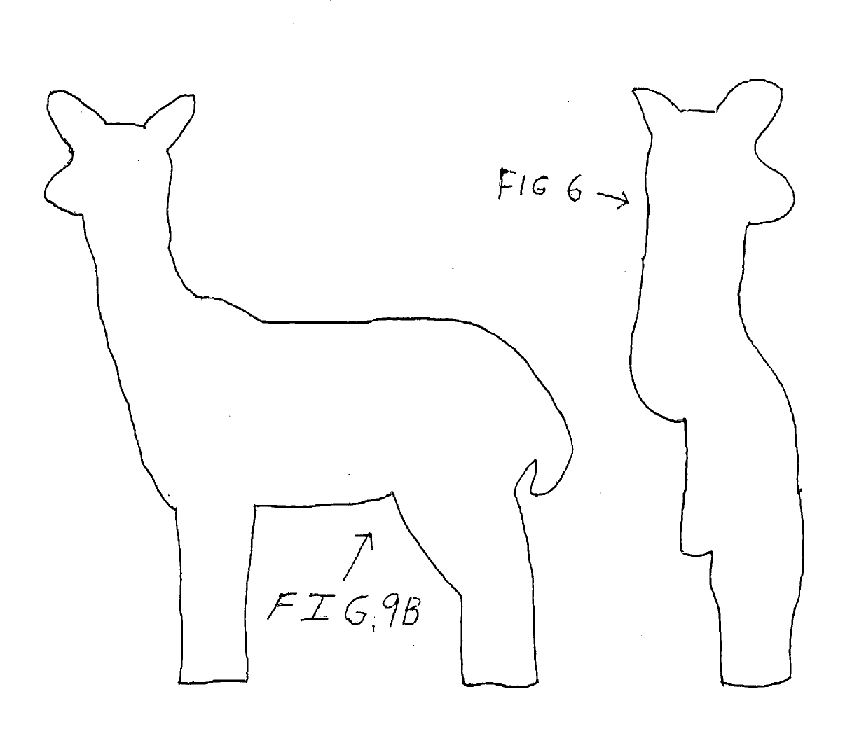

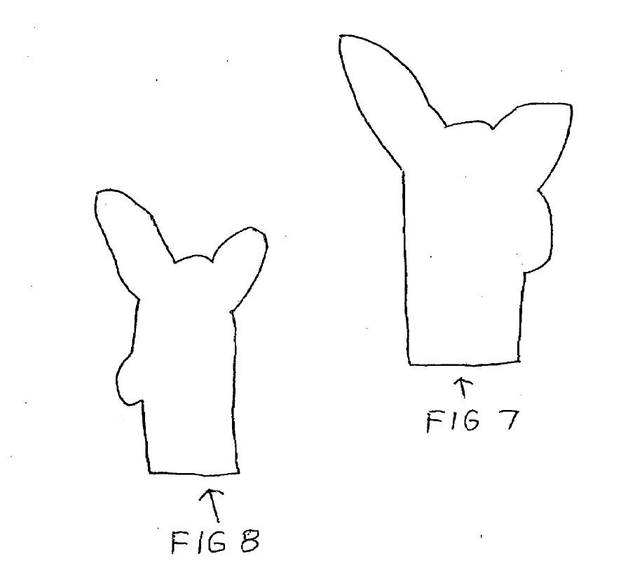

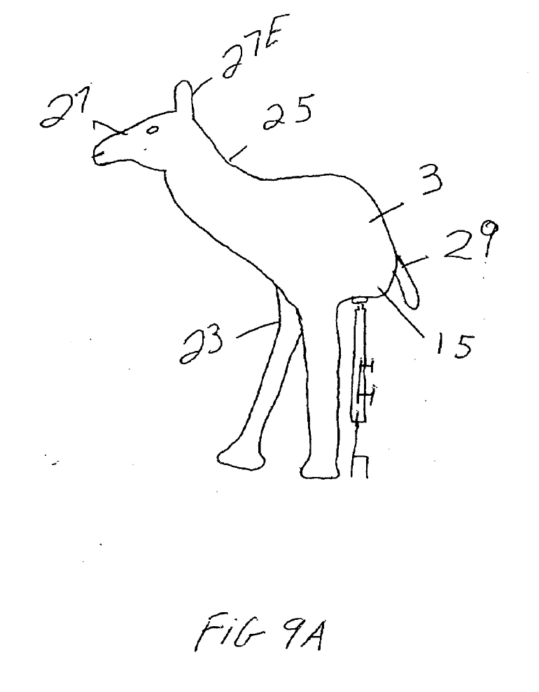

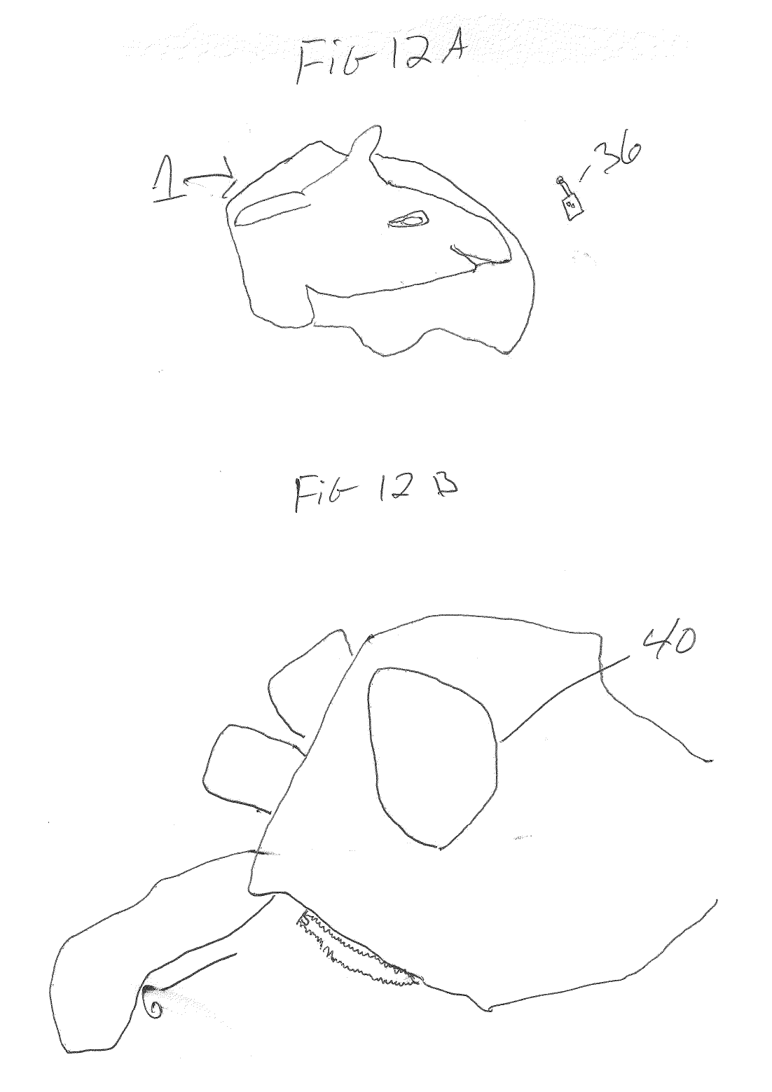

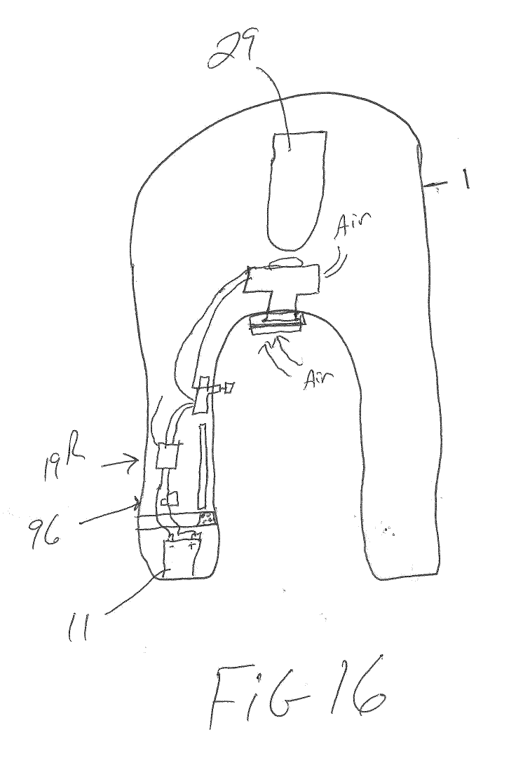

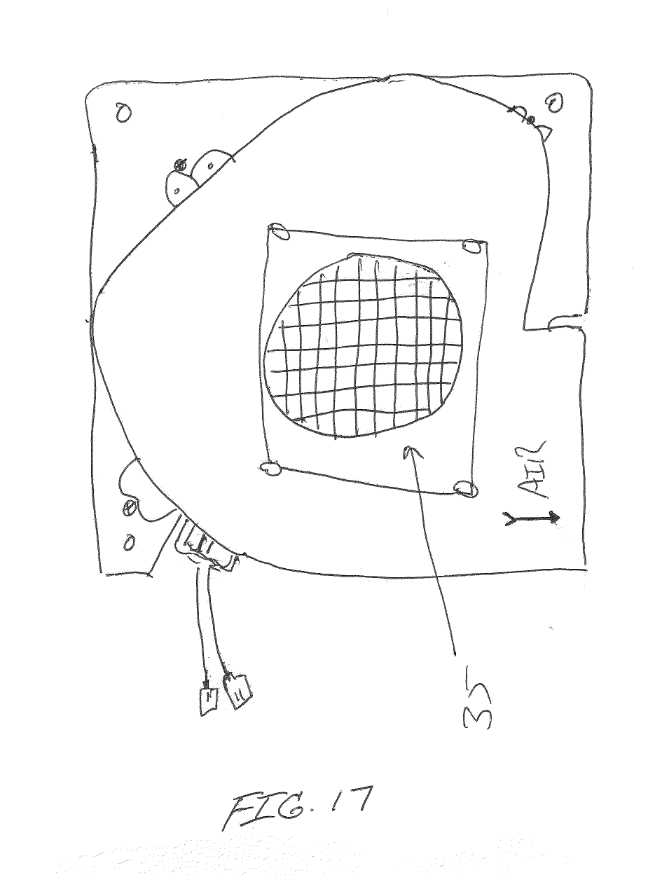

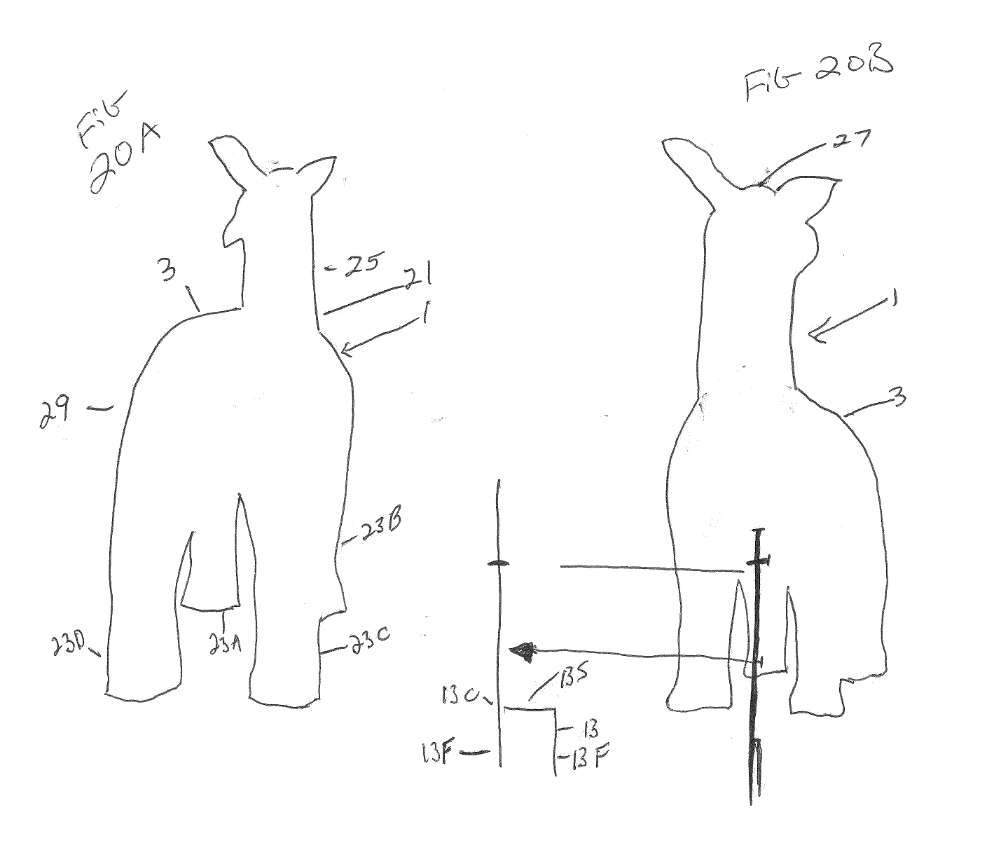

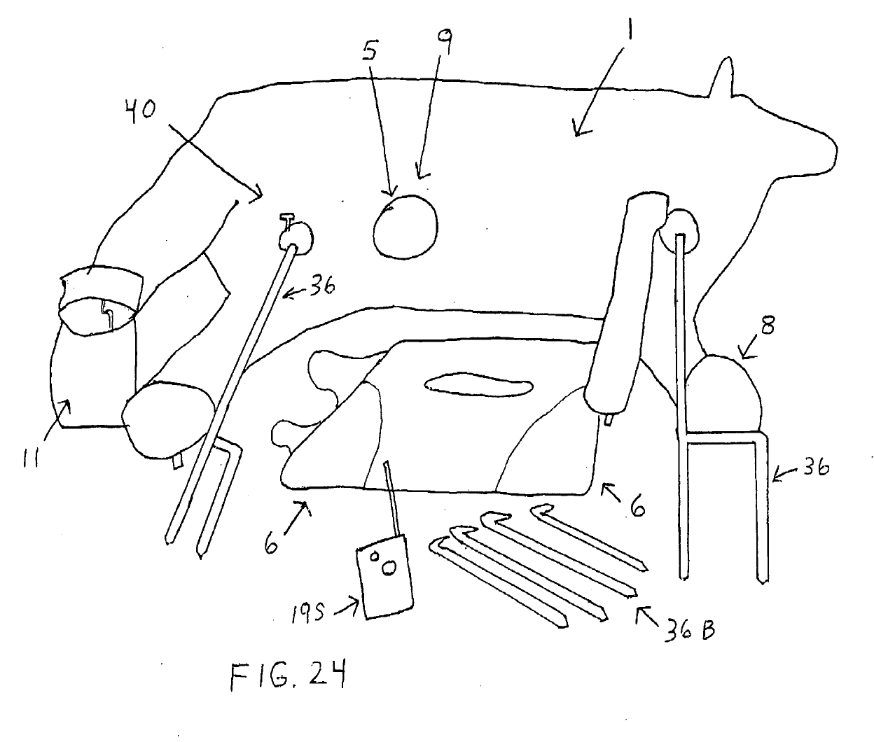

Referring to the FIG. 1-24, the present invention provides a decoy 1 which upon inflation provide a resemblance to a desired prey (e.g. see FIGS. 1-4 and 10) at a hunting site while upon deflation (e.g. see FIG. 11) provides a compact and transportable decoy 1 as illustrated. The decoy 1 comprises an inflatable and deflatable decoy body 3 having an internal cavity 4 for retaining pressurized air upon inflation, an ambient air source 5 for supplying air and an ambient air pressure source 7 (e.g. cold air) equipped with a battery powered motor 9 and a battery 11. The decoy 1 possess sufficient structural support to initiate and maintain the decoy 1 in an upright position when being inflated while also allowing the decoy 1 to collapse onto a stowable position when deflated. A partial leg restriction 40 as depicted in FIG. 19 and a flexible support member 13 (e. g. see Photographs 13, 16, 20A & 20B) may be used upon inflation to assist in initiating and maintaining the decoy 1 in an upright inflation position.

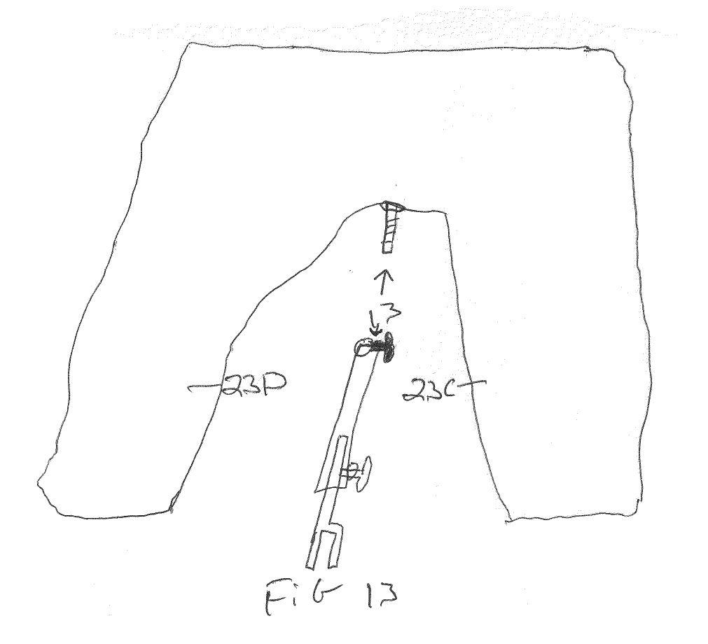

With reference to FIGS. 1-4 and 10, the body 3 is appropriately provided with a torso 21, legged appendages (prefixed by 23), a neck 25 with a head section 27 and a tail section 29 being oppositely positioned from the head section 27. The decoy body 3 may be constructed of any flexible material possessing sufficient air entrapment characteristics to allow the decoy 1 and the internal cavity 4 (as partially shown in the internal leg view of FIG. 19) to inflate to an inflated standing position (e.g. FIGS. 1-4 and 10) and collapse upon deflation (e.g. see FIG. 11) to a stowable and transportable position as illustrated by FIGS. 12A & 12B. As may be observed from FIGS. 12A & 12B the depicted decoy 1 possess sufficient flexibility to be stuffed into a tote bag 6 for ease of transport without necessitating an orderly folding into a more neatly and compacted form. The material construction of the body 3 should desirable be a material having a sufficient resistance to withstand deterioration upon the demands of rigorous hunting use, transportable in a gathered or foldable deflated state while also being sufficiently rigid and air tight to maintain a positive internal pressure upon inflation and a standing position. Exemplary body 3 material include flexible substantially air impermeable materials constructed of a tear and puncture resistance material as well as having sufficient flexibility to permit inflation and deflation for gathering into a stowable and transportable position without substantially altering its ability to retain an inflatable air pressure within the body 3 after repetitive use.

The inflated decoy 1 may be most suitably constructed of a body 3 characterized as being field durable along with puncture or tear resistant with sufficient resistant to stretch upon inflation (i.e. low stretch potential) so as to maintain its inflated decoying dimensions without any substantial undesirable bulging. The body 3 typically includes a base fabric (e.g. nylon or polyester) of a conventional weave or weft inserted weave. There exists certain advantages in fabricating; the body fabric from woven nylon fabrics having weight of less than about 5 oz. per square yard and typically less than about 4 oz. per square yard of weight. If the weight becomes excessively heavy, then the pressure source 7 typically needs to be increased which tends to increase noise output, power consumption and adds unnecessary weight. The base fabric provides the field use durability with an ability to inflate and retain its desired dimensional size upon inflation while also permitting upon deflation and an ability to quickly gather together the body into a stowable form for ease of transport. The base fabric also contributes rigidity to the inflated structure to facilitate and maintain an upright or standing decoying posture. An illustrative coated woven nylon fabric which performs very well is a polyurethane coated 200 Denier Oxford Nylon sold and distributed by Westmark Inc. of New Hampshire.

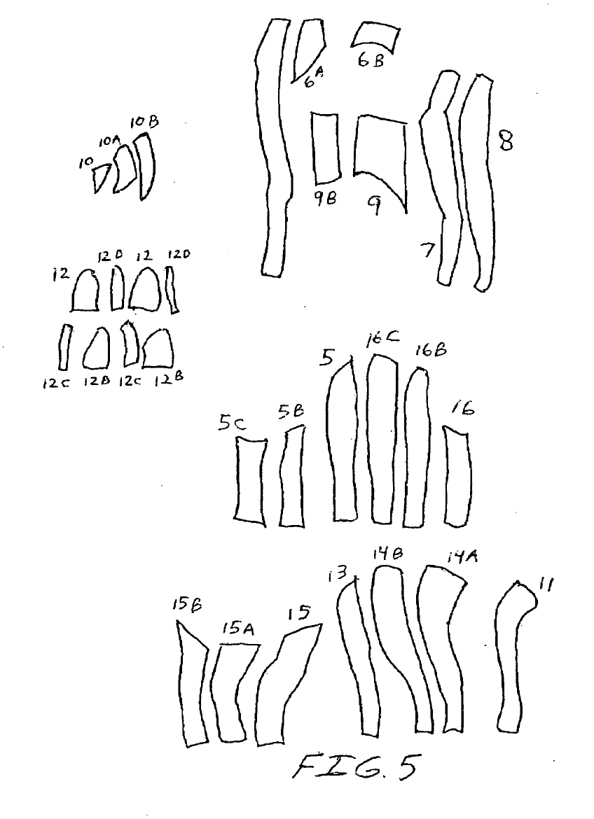

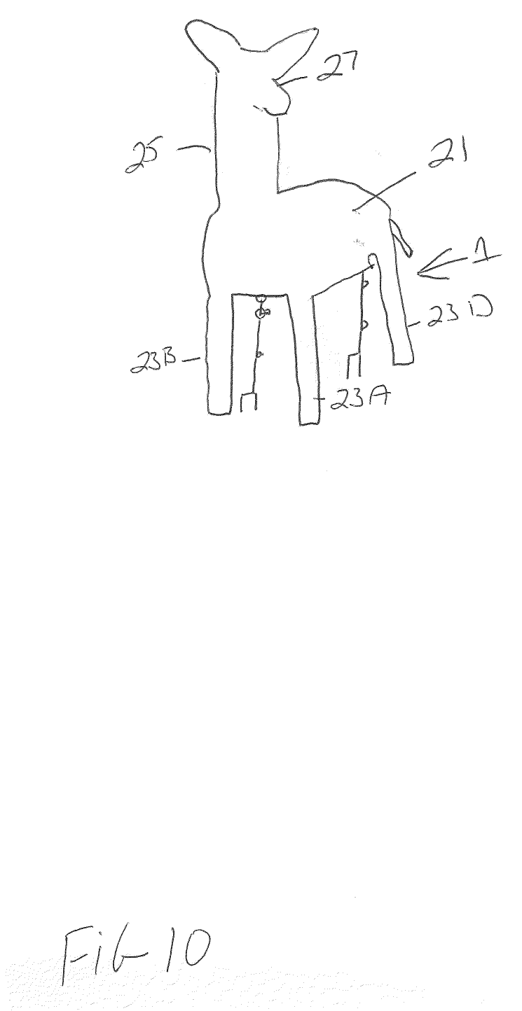

Referring to the Figure, it will be observed that FIGS. 1-4 respectively depict a left side, a frontal and top side view of deer decoy 1. FIGS. 9A & 9B depict numbered pattern cut pieces (each having a designated number) which are adapted to be sewn at the corresponding positions as enumerated on FIG. 4-7. The adjacently positioned cut pattern pieces of the enumerated sections may be appropriately overlapped and stitch sewn together to yield the depicted decoy 1. Sewing or seaming the numbered pieces together provides a strong and durable decoy material body 3 having stitched seams which further contribute reinforcement, strength, toughness, and resistance against puncturing and tearing as well as other functional purposes as explained later in more detail.

The base fabric typically fails to possess sufficient air retention properties to be used solely by itself as the decoy body 3. Air imperability is typically imparted to the base fabric by a fabric coating. Such coating generally fall within the classifications of thermoplastic (e.g. polyvinylchloride, polyurethane, elaloy, aqualoy, etc.) and thermoset plastics such as neoprene (cured or uncured), hypalon etc. The polyurethane coated base fabrics have been found to be particularly well suited for the decoys 1 of this invention. The commercial thermosets generally provide a more durable coating than the thermoplastic fabric coatings. There also exist for use what is commonly referred to as unsupported fabrics which may also be used.

With particular reference to FIG. 4-7, 9A and 9B, the decoy 1 is most appropriately constructed of patterned sections Joined together to provide an inflatable decoy 1. Depending upon the particular fabric coating and the desired manufacture the patterned sections may be appropriately seamed together. Certain fabric materials coated with a vulcanizable material (e.g. neoprene) may be used to vulcanize the sections together. Similarly other cross-linkable polymers may be activated to create the desired seamed sections. Similarly the heat sealing of the thermoplastic coated fabrics may be used to seam the sections together. Alternatively glues may be used for seaming the sections together. There exist several alternative approaches to seaming the patterned sections together to create the desired decoy body 3. However, there exists definitive advantages when the depicted decoys were stitched or sewn together. The stitched sections of the decoy 1 need not provide totally air tight internal cavity 4. A controlled air loss or seepage while intermittently or continuously running the air pressure source 7 provides certain advantages during decoying use while also serving to assist in the deflating of the decoy 1 for stowing by the hunter.

The decoy 1 may be used as a decoy for any hunted game having a tail 29, head 27, legs (generally prefixed by 23), a neck 25 and a torso 21. Although the decoy 1 may be used to decoy a wide variety of hunted game such as water fowl (e.g. ducks, geese), upland fowl (e.g. turkeys, grouse, etc.), the decoy 1 is particularly well adapted as a hoofed animal decoy 1 for decoying animals such as deer, moose, elk, antelope, mountain goats, etc. A hoofed animal decoy 1 is typically equipped with four legs (23A, 23B, 23C & 23D) as depicted by FIGS. 1-4 and 10 which serves to support the body 3 in an upright position when inflated.

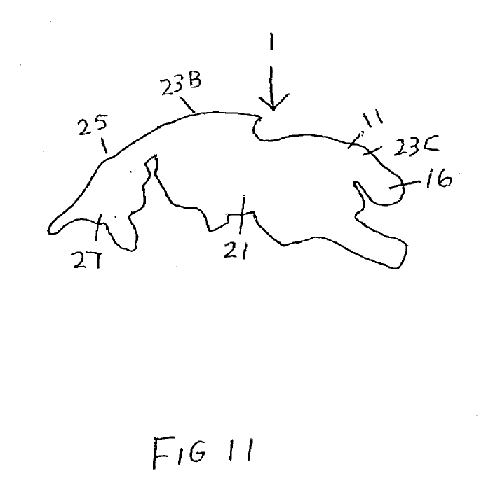

In a decoy 1 having a single or baffled air internal body cavity 4, the body sections positioned more remote from the pressurized air source 7 (e.g. head 27 or tail 29) will typically possess insufficient air pressure to maintain the decoy 1 in an upright position. For decoys 1 adapted for remote inflation as depicted by FIG. 10-11 and 14-17, it is also important that the decoy 1 undertake an upright standing position upon commencing a partial inflation and complete inflation of the body. Thus, if the air flow upon inflation remains unregulated without any precautions to initiate a desired standing decoy position or maintenance thereof, the weight of a partially inflated body 3 may lead to a decoy 1 resting in a prone or side position.

With particular reference to FIG. 1 Q, the decoy inflation for decoys 1 pressurized through leg intake may be suitably commenced under conditions to provide a more localized and increased pressure within at least one of the legs 23 so that the decoy 1 may then inflate and assume a standing posture. By applying an unequal pressure to initially inflate at least one leg 23 (shown as 23C) to an upright position, inflating the decoy 1 onto the standing position may be effectively accomplished. Initiating a higher inflation rate of one leg 23 such as the depicted 23C leg before inflating the remaining balance of the non-legged decoy chamber 4 or body 3 may be effectively achieved by placing a valve or air restricted passageway 40 positioned in an upper internal portion of the leg 23 near the torso 21 as depicted in FIG. 19. Although the depicted restricted passageway 40 as shown in FIG. 19 depicts a rather large sized opening comparative to the internal leg cavity of leg 23A, it still effective serves to restrict air passage flow into the main torso chamber 4 and thereby allows the restricted air flow of the leg 23A to inflate sufficiently to initiate and maintain the desired upright posture. This also facilitates air flow into the other legs 23 as well as the air chamber 4 as a whole. In the absence of inflating at least one leg 23 (shown illustratively as 23) before inflating the rest of the body cavity 4, it is difficult without some other manual assistance or supportive means to inflate and maintain the desired upright decoy positioning. For remotely switched inflations it is particularly important that the decoy 1 include a means to initially place the decoy 1 in the proper standing position.

The internal cavity 4 of a multiple legged decoy 1 may also be equipped with other types of baffling members 40 which selectively direct the initial air flow during inflation towards one or more legs 23A, 23B, 23C & 23D. Such a selective directional air flow allows legs 23A, 23B, 23C & 23D to inflate to a supportive position before full inflation of the torso 21, neck 25, and/or tail 29 commences. The baffling member 40 may internally extend along a bottom margin of the torso 21 juncture onto one or more legs 23A, 23B, 23C & 23D and thereby serve to baffle or restrict initial air flow into the torso cavity 4 portion of the decoy 1. This allows the legs 23 to assume an upright position while setting the stage for the balance of the body 3 to inflate onto the proper standing position. Similarly funneled internal tubes (not shown) leading from the air pressure source 7 to the leg cavities 4 may also applied to establish an initial or sequential inflation of the desired legs 23.

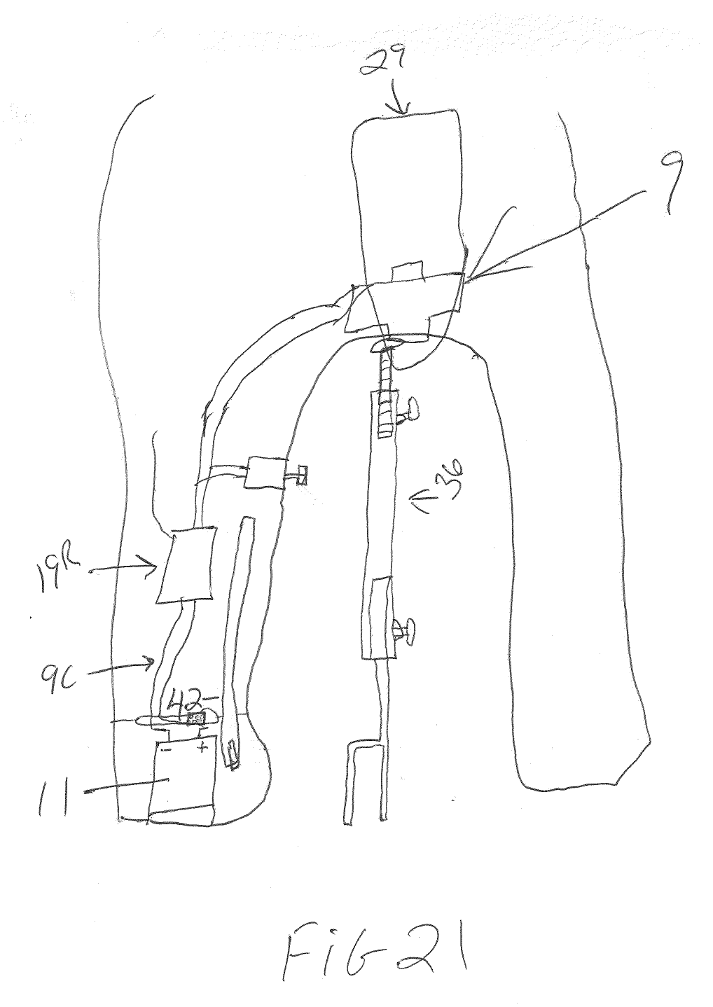

If the decoy 1 as illustrated by FIGS. 11 and 16-19, includes the motor driven fan 10 or other weighted pressure source components, the motor 9 and fan 10 weight when positioned in an inflating foot such as leg 23A or any other foot will normally be sufficient to ground the inflating leg 23. Similarly during inflation small weights or stakes 36 (shown in FIG. 12A) secured to stake retaining sleeves or pockets 38 may be used to facilitate retaining legs (e.g. 23B, 23C & 23D) in the appropriate grounded position during inflation as well as protecting against being wind-blown from the decoying site. Alternatively or cooperatively with stakes 36, the braces as illustrated by FIG. 20A, 20B and 21 may be used to anchor and assist in maintaining the decoy 1 upright during inflation.

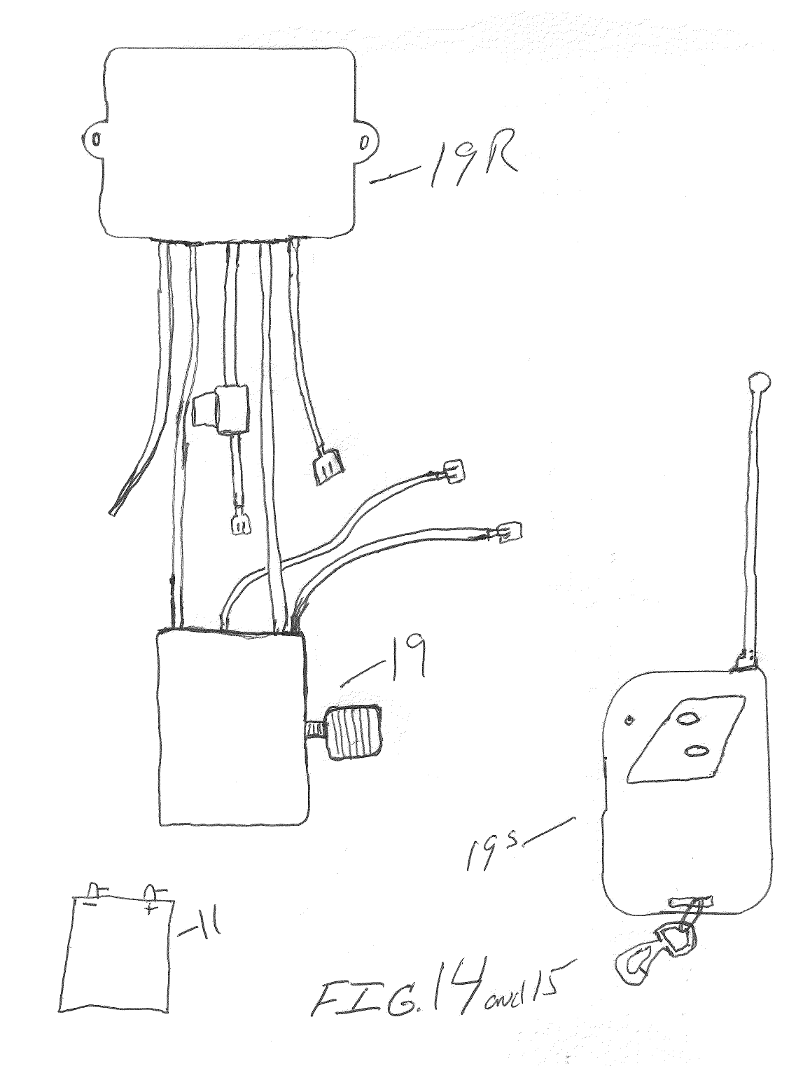

If the legs 23A, 23B, 23C & 23D are constructed of materials or reinforcements sufficient to maintain the decoy 1 in an upright inflated position, then extra bracing will generally not be required. As indicated, the inflation of one leg 23 generally initiates the initial upright positioning so that the other legs 23 are then accordingly positioned to undertake a standing supportive position which allows the decoy 1 to undertake a standing inflated position. In the absence of selective multiple leg 23 inflation techniques, it is desirable however, to provide additional leg brace structural support 13 to help maintain the decoy 1 in a standing position. Such additional support may be achieved by adding a brace support 13 to the legs 23 and especially those legs 23 distal to the pressure source 7 as may be observed from FIGS. 13, 20A & 20B and 21. For example, the distal leg support may be re-enforced with bracing such additional body 3 cover material or as a separate brace support 13. By providing an upright support member 13 to legged appendages 23 pc sitioned at those legs 23 more distal to pressure source 7, an upright or standing decoy position may be more easily achieved at a relatively low cost. An arched supportive brace 13 (external or internally disposed) bridging between the two legs (23C & 23D) of sufficient rigidity positioned distal from the pressurized air source 7 as shown in FIGS. 13, 20A and 20B may be used to effectuate this result. For example, a flexible plastic or metal wire or strap possessing good springed or memory characteristics (bridging adjacent legs 23 internally or externally) so as to return to its initial shaped position upon applying pressure at opposite brace 13 ends may be effectively used for this purpose. An exemplary flexible brace 13 may be constructed of a steel wire or stainless steel strip or rigid plastic in an arcuate form so as to bridge between the two adjacently positioned legs and sewn to each of the legs (e.g. 23C & 23D) outside or within the internal body cavity 4 may be used for this purpose. If desired the legs 23 may be equipped with brace support sleeves or rings 13R to permit the insertion or removal of the brace 13 from its bracing position.

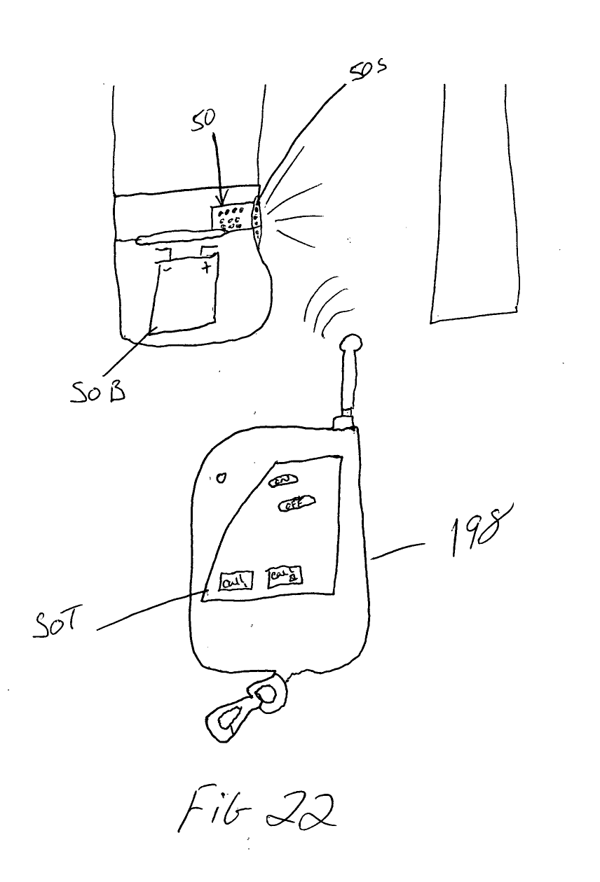

A supportive leg brace support 13 is depicted by FIGS. 13, 20A, 20B and 21. The bridging supportive brace 13 may be sewn or otherwise attached sleeved, ringed or anchored, etc. onto both legs 23 so as to impart a supportive upright standing decoy posture as shown in FIG. 1-5. in a decoy 1 having a single cavity chamber 4, the ambient air may be appropriately admitted at one of the legs 23 equipped with an internal baffle 40 to allow more rapid inflation of the baffled leg 23. Under operational inflation conditions, the chamber region closest to the air inlet 15 and pressure source 7 typically retains more air pressure than those legs 23 positioned at a more distal position. By positioning the supportive brace 13 bracing between the legs 23 farthest from the air pressure source 7 an enhanced upright decoy standing position is thereby achieved. If desired, the supportive brace 13 may also be used to support both the front and rear legs 23. The braces 13 may also be used to achieve certain design changes that cannot be necessarily achieved without the brace support 13 or some other means to maintain a desired upright posture. In the absence of brace 13, the diameter of the legs 23 normally has to be increased. However, leg braces 13 may be effectively used to reduce the leg diameters to less than 4 inches and typically to less than a 3 inch diameter size. Also the braces 13 with or without leg stakes 36 may be used to anchor the decoy 1 to the ground. FIGS. 20A, 20B and 21 disclose braces 13 which may serve to stake the decoy 1 to the ground and support its upright standing position. The brace 13 shown it, FIGS. 20A and 20B when properly positioned allows the decoy 1 to deflate onto its side. The brace 13 of FIGS. 20A and 20B may be supported by rings, sleeves, Velcro sleeves or any other supportive means which allow the brace 13 to remain or be removed after deflation. Since the brace 13 may pivot within its sleeve, the braces 13 will not interfere unduly with its stowability. With particular reference to the brace 13 shown between the rear and frontal views of FIGS. 20A and 20B, the brace 13 may include the depicted foot stop 13S which may be effected used to drive the two forted prongs 13F to be driven into the ground. If desired, a brace connection Be may be alternatively used to disconnect the lower and upper brace 13 sections.

Other means for imparting a bracing effect to the legs 23 may also be used. If desired the decoy 1 may be provided with multiple compartment chambers 4 or air pressure source 7 equipped with flutter shut off and release valves (not shown) or baffles 40 (e.g. such as shown in FIG. 19) to shunt the air flow to thus obviate the need for a supportive brace 13. The brace 13 in the distal legs to the pressure source 7, however, provides an economic means to provide the desired upright standing position.

The decoy 1 may also be provided with multiple compartment cavities (not shown) equipped with, positive pressure valves to maintain a substantially uniform internal pressure or selectively throughout the decoy internal cavity 4 to assist in the maintenance of an upright standing position when the decoy 1 is fully inflated. This alternative feature typically requires an air outlet 17 onto each compartment which may regulate air flow and a pressure source 7 equipped to provide a desired positive inflation and deflation pressure. Such features are generally more costly and burdensome for field use than a single cavity 4 equipped with the supportive leg brace 13 with one of the legs junction to the air source having an air flow baffle 40. Such multiple or single compartment 4 decoys 1 may also be used as a means to create movement in decoying body sections (e.g. tail 29 and head 27 or neck 25)) by a valve system regulated under remote control. In a decoy 1 as illustrated by the Photographs and Figure the tail 29 and head 27 portions are more susceptible to a pressure lose or deflation because of their distal positioning to air source and thereby can be remotely controlled by regulation of the pressure source 7 to induce head 27 or tail 29 movement.

With particular reference to FIGS. 11 and 14-19, the ambient air pressure source 7 may be comprised of any inflation unit 7 which provides a positive ambient air pressure for inflating the decoy 1. The ambient air source 5 includes an ambient air inlet 15 and an inflation outlet 17 for releasing the intake air into the body 3 and a switching member 19 for operationally controlling the inflation unit 7. A battery 11 serves as the power source. In order to provide an animal prey appearance, the body 3 may be colored and designed so as to simulate that of a desired hunted prey. If desired the decoy 1 may be equipped with a reversible motor 9 which upon switching reverses fan 10 rotation to thereby vacuum air from the chamber 4 and deflate the decoy 1. In the depicted stitched decoy 1, the inflated decoy 1 will readily deflate to a stowable deflated decoy 1 upon cessation of air pressure from the inflation unit 7 which may arise by cutting the D.C current flow to the fan motor 9.

The pressure or inflation source 7 may be suitable supplied by a battery powered motor 9 operationally powering a fan 10 housed most appropriately within a leg 23 of the body 3 or in proximity thereto for accessing onto an ambient air pressure inlet 15 for inletting the pressurized air into the decoy cavity 4. The pressure system herein relies upon unheated air which is often referred to as cold air inflation. As illustrated in FIGS. 11 and 14-19, the remote power sensor 12, power switch 9S and battery 11 may be most appropriately positioned outside of the internal cavity 4 with a power cable 9C supplying the D.C for powering motor 9 and fan 10. External placement of the depicted decoy 1 components provides a more stowable decoy 1.

Although the figs depict positioning the motor driven fan 10 within the internal confines of one of the legs 23, the fan 10 and air source 7 may be positioned anywhere within or outside the body 3. For example air pressure conduits (not shown) externally fed by an external motor fan 10 system may be used to inflate the decoy 1. Similarly, the fan 10 may be driven by a flexible cable (not shown) powered by an outside motor. Further illustrated thereof is a decoy 1 depicted with its head 27 down in a feeding site pressurized by an air flow intake 17 to the head section 27 with or without head movement or other means to attract the prey.

Under hunting conditions, the battery operated motor 9 and fan 10 should be maintained at a sufficiently low decibel level so as to not spook and destroy the desired decoying effect of the decoy 1. This may generally be accomplished by utilizing a motor driven fan 10 possessing sufficient operative features to maintain the decibel output of the pressure source 7 at less than about 75 decibels. Typically this desired low level decibel output may be achieved using a variable speed direct current motor 9 operationally driven under operational conditions which maintain the motor 9 and fan 10 decibel output at less than about 60 and particularly less than about 50 decibels. By regulating the voltage output for driving the motor 9 at a voltage ranging from about 6 to about 48 and particularly at less than 24 this objective may be generally accomplished. Other means for controlling or regulating the power input into the power source 11 may also be used to effectuate this purpose. The fan 10 size, the cubic displacement feet of the inflated decoy 1, body weight and air permeability characteristics are factors bearing on the sound level created during operational inflation periods, By increasing the fan blade size and operating at a relatively low fan speed (possibly by a variable speed motor 9 remotely controlled) the decibel level produced by the air pressure source 7 is inflating and maintaining inflation of the decoy 1 can be substantially reduced.

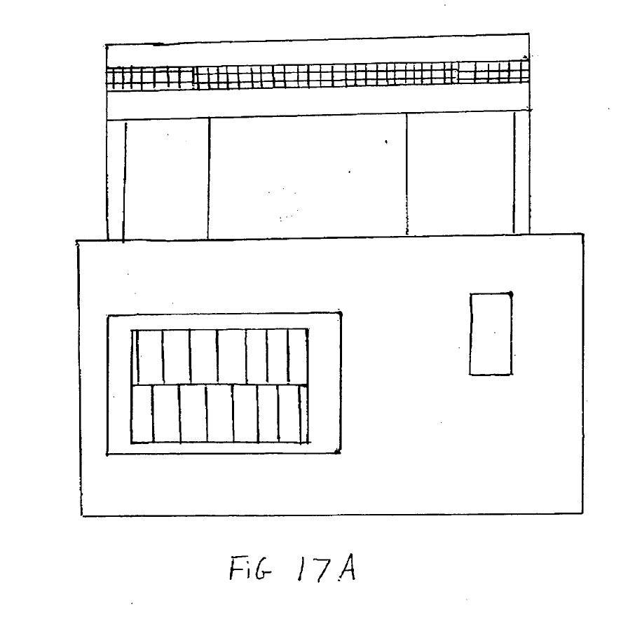

A suitable fan 10 may be a multiple bladed fan 10 rotated around the motor driven axis 9A as illustrated in FIGS. 16-18. Although a host of suitable construction materials may be adapted to the fan 10, a molded and durable fan 10 (fabricated from durable plastic materials) typically used in small fan manufacture will appropriately serve this purpose. The rotating fan 10 rotating at prescribed rotational speed and decibel output effectively serves to inflate the decoy body 3 and maintain the inflated decoy body 3 at a desired inflation pressure. As previously mentioned, voltage control at a prescribed D.C voltage serves to effectively maintain the fan 10 and motor 9 at the desired rotational fan speed while also affording a low decibel output so as not spook the desired prey. Although the decoy 1 is most suitably designed to readily collapse upon cessation of the battery power 11, the motor driven fan 10 may also be equipped to help deflate the decoy 1 by reversing the rotational directions of the fan 10. The motor 9 is most appropriately a D.C variable speed motor operable at about 2 to about 24 volt rating and more appropriate at about 6 to 14 volts.

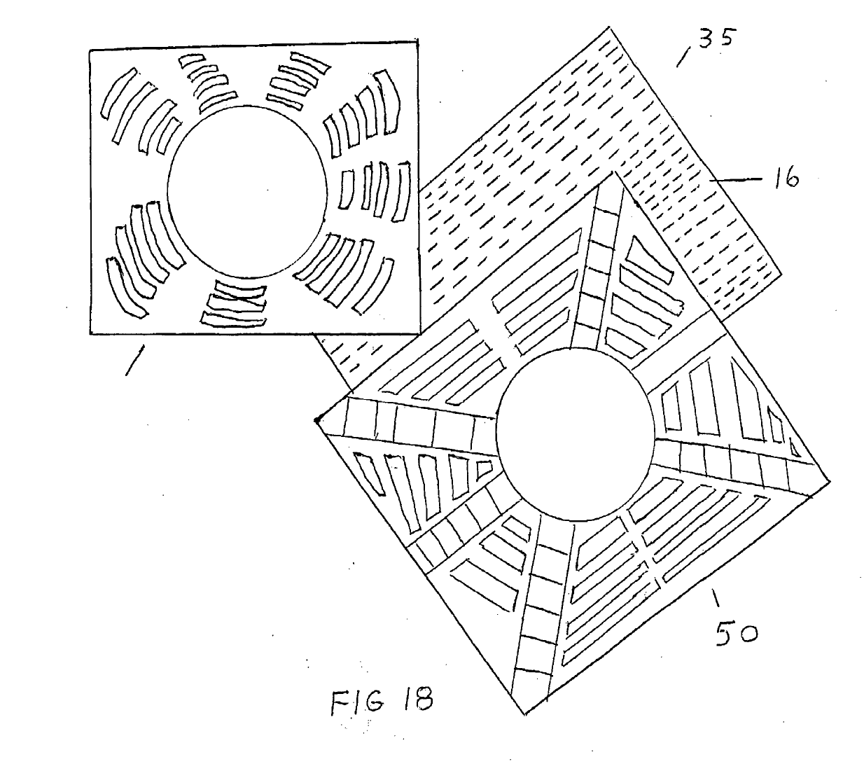

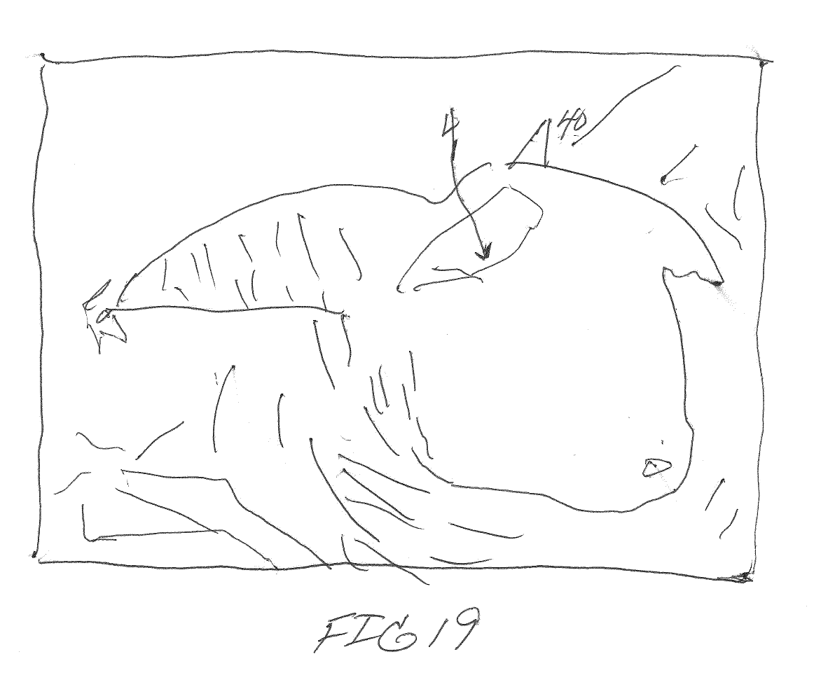

With reference to FIGS. 17-18, the fan 10 may be provided as a squirrel caged fan 10 which tends to reduce fan noise and provide a more open compact fanning source. The fan 10 along with the motor 9, may be especially designed for placement within the leg cavity 4L or any other desired body 3 location. The leg 23 may suitably be provided with an accessing port 42 which provides access to fan 10 and motor 9. Although the fan 10 and motor 9 may be housed outside the leg cavity 4L, it is desirable to house the fan 10 within the leg cavity 4L to reduce fan noise while also to weight the leg 23 for grounding the foot during inflation. The inlet 15 is also preferably provided with an air filter 16 to prevent pressure source 7 fouling with external contaminants (e.g. dirt, dust, leaves, grass, etc.)

The power source 9 for inflation and deflation may be most appropriately remotely controlled which allows the hunter at the hunting site to inflate and deflate the decoy 1 from a hunting site remotely positioned from the decoying site. This feature is important since a hunter being distally removed from the hunting site is thereby less prone to spook the prey. The feature also allows the hunter to preserve battery 11 reserves. Creating prey attracting movements distant to the actual decoying site also tends to attract the hunted game towards the decoy 1 and not the hunter. By regulating the amount of pressure within certain attractant body parts, body movement may also be effectuated.

The decoy 1 may also be suitably equipped to provide motion to those body sections generally recognized as having a desirable decoying effect upon the hunted prey. Such decoying sections generally comprise the tail 29, the neck 25 and head sections 27 of the decoy 1. Movement of either the head 27 or tail 29 sections of the decoy 1 may effectuated by the level of pressurized air admitted to the inflated decoy cavity 4 including those body parts connected to the torso 21. Since those body extremities distal from the pressure source 7 tend to deflate more readily than those sections closer to the pressure source 7, movement of either the tail 29 or head 27 may be accomplished by regulating the pressure level within the decoy pressurized chamber 4. Accordingly by intermittently regulating or alternatively by sensory regulation of the internal cavity 4 pressure, the distal movement of a desired body part may be achieved. This effect may be accomplished by intermittent switching of the emote power source 9 to on or off position to create the desired body part motion. Alternatively the decoy 1 may be provided with sensors 12 internally positioned within the body 1 to switch the power on or off within a desired internal body pressure to create a desired movement. Similarly, the neck 25 and head sections 27 may be equipped with compact and light weight D.C motors 9 operationally equipped with a mechanical arms or levers (not shown) or other means for instituting the desired body section movement. A deflated deer decoy 1 arising upon inflation tends to arise in a manner similar to lying deer which tends to create a highly decoying attractant to the prey.

The tail 29 may also be provided as an add-on attachment for attachment to the inflated or deflated decoy 1. Among the attachable deer tail decoys include a deer tail decoy such as disclosed to D.S Pat. No. 6,510,644 B1 to B. Gollnik. This attachable deer tail decoy includes a tail having a decoy attractant configuration. The decoying tail includes a flexible background material secured to a support member and an overlaying top section both of which may be fabricated of contrasting colors similar to those of a deer tail. Both the flexible background material and overlaying top section contain slotted cuts about their outer material periphery to create individual flaps which when suspended in air currents or wind tend to flap in a manner simulating a deer tail. The deer tail typically includes a mounting member such as a wire rope, string, strip, Velcro strips, etc. which allows the deer tail decoy to sway and move with the wind currently to create a fluttering tail hair simulating movement. The rump section of the deer decoy 1 may accordingly be provided with a tail mounting member such as a snap fastener, hook, male and female fastener (e.g. Velcro) and the like. Alternatively the tail attachment may be integrated into the body 3 of the deer decoy 1. Other deer tail simulating decoy may similarly be used and mounted to the body 3.

In order to effectively serve as a hunting decoy, the decoy 1 should be of light weight so that upon deflation it collapses into a relatively compact form which may be stuffed or packed into a tote bag 6 for ease of transport. The decoy 1 size will depend upon the animal or fowl desired to be decoyed by the decoy 1. An illustrative deer decoy 1 may measure from about 3 to about 6 feet height, about 1 to about 2 feet in width and about 3 to about 6 feet in length. The deer decoy 1 may be constructed of component parts weighing less than 15 pounds and most typically less than 10 pounds. Such deflated deer decoys 1 may be easily rolled, folded or just stuffed into a tote bag 6 of less than about 3 cubic feet and most typically less than about 2 cubic feet of course for larger animals such as elk the weights, dimensional sizes, cubic feet placement values in the deflated position etc. will correspondly change.

The light weight attributes of the body 3 may be achieved by using light weight materials constructed of heavy duty synthetic or plastic materials. Similarly, light weighted materials may be used in providing the D.C motor 9. The fan construction may also be made of light weighted plastics or metals. Although the power source 11 may comprise any portable power source 11, a light weight battery 11 serves as the most appropriate power source 11. There exists a broad array of batteries 11 which may serve as the power source 11. However, within recent years great strides have been made in providing light weight, long lasting and a powerful power battery sources 11. Amongst such developments are the lithium batteries 11 which contribute a light weight while also providing a powerful and long running battery power source. Lithium batteries 11 typically of about 6 to about 48 voltage rating serve as a particularly effective power source 11. In order to obtain a low decibel output, a lithium battery 11 of about 9 to 14 voltage range for operational use with a battery powered variable speed D.C motor 9 may be adapted to drive the fan 10 at a low decibel level.

It is know that various different scents will attract or repeal wild hoofed animals and other wild life. For example amongst the deer family (e.g. deer elk, antelope, etc.) attractant scents include rutting scents and animal food scents such foliage, nuts, corn, legumes (e.g. alfalfa, soybean, etc.) cereal grains (e.g. oats, wheat, rye, barley, etc.) and the like. In alternative version of the decoy 1, the ambient air pressure source 7 may be provided with a scenting member 33 which administers a desired decoying scent. With particular reference to FIGS. 1 and 18, the inflated decoy 1 may be accordingly equipped with a scent emitting system 33 to emit a desired scent so as to attract a desired hunting prey. The decoy body 3 may appropriately be provided with a scent disseminating orifices 31 allowing the scent to be released from the air cavity 4 while also preserving sufficient air retention characteristics to maintain the decoy 1 in its inflated position.

Under normal operations the decoy body 3 may be designed so as to allow scent under the cold air pressure system within the inflated chamber 4 to escape through porous intercies provided within the decoy body 3 while still retaining sufficient air pressure to maintain the decoy 1 in a stable inflated hunting position. Normally the stitching used to sew the various pattern cuts together as illustrated by Photographs herein will allow for a slow seepage of scent from the decoy cavity 4 into the surrounding atmosphere without causing a significant loss in inflation to obstruct the desired upright standing decoying position.

As mentioned, the sewn stitches of the body 3 typically provides a sufficiently air tight chamber 4 so that the level of air loss or seepage is substantially less than the total air pressure provided to the body chamber 4. This system serves as an effective means for dissipating a desired scent from the decoy 1. Since the air seepage through the stitches is substantially lower than the level of cold pressurized air provided or admitted to the chamber 4 by the air pressure source 7, the seams do not accordingly compromise the pressure source 7 capacity to retain the decoy 1 in the inflated position. If desired, a partial stitch sealing while leaving sufficient unsealed stitches so as to allow the scent to escape from decoy internal cavity 4 may also be used for this purpose. However, the decoy 1 performs well without requiring any stich sealant while also permitting a rapid responsive deflation. Alternatively small porous openings or orifices (not shown) in sufficient number to emit an effective scenting odor to attract the attention of the hunted prey may be used if the stitches are effectively sealed. The decoy 1 may also be remotely controlled with scent emitting attachments relying upon means other than the stitched seams to emit the scent.

A convenient scenting means 35 for admitting the scent to the internal decoy cavity 4 entails placing the scenting member 35 in a downwind or upwind position from the fan 10 as depicted by Photographs 17 and 18. As illustrated, placing a scent releasing container 35c (e.g. a bag) containing the desired scent above the fan 10 discharging end or at the fan air intake side as depicted by the Photographs and figs allows a desired amount of scent to be forced throughout the decoy 1 for subsequent emission through the sewn stitching pores. In this arrangement the scent container 35c may have a desired porous structure so as to vaporize at a desired predetermined rate level of scenting material. As depicted by FIGS. 17 and 18, the scenting system 33 may be designed for attachment to either the fan outlet or inlet side with an accessing member 18 shown as a zipper as depicted in FIGS. 12A, 12B and 16 permitting access onto fan inlet 15 so as to allow replacement replenishment or removal of the scenting material.

Under normal hunting conditions, the decoy 1 will be inflated at the hunting site most often under windy or gusty conditions. The air inflated decoy 1 is accordingly susceptible to be blown away from a desired decoying site. This problem may be overcome by providing the decoy 1 with anchoring features for maintaining the decoy 1 at the desired anchored sites. Although weights within the internal cavity 4 (especially the legs 23) help to maintain the decoy 1 at the hunting site placement, such weights also tend to add unnecessary bulk and weight. This detracts from the more desirable lighter and easier transportable features of the desired decoy 1. Although guy strings or wires may be used to anchor the decoy 1 to the ground, such guy strings and wires are more difficult to transport and set-up and may spook the decoyed animal. Although any anchoring means which substantially secures the decoy 1 to a specific decoying site may be employed, providing the legs 23 with stake retaining pockets or sleeves 38 for staking the decoy 1 with stakes 36 to the ground site provides a highly effective anchoring for the inflated decoys 1. Also as previously mentioned leg braces 13 with forted tongs 13F or brace 13 staked ends may also assist to maintain a grounded decoy 1.

The decoy 1 may also be equipped with an audio unit 50 to emit an electronic signal or sound serving as a decoying audio attractant for be prey. The desired attractant sounds may he digitally prerecorded onto a MP3 player, SD, micro SD, chip or any other digital means, etc. for vocalizing a desired animal call. With reference to the schematic drawing of FIG. 1, the audio unit 50 may accordingly be equipped with a digital sound source SOD, an electronic speaker 50S for amplifying a digital sound and an electronic switching receiver SOR powered by a battery SOB most suitably activated by a remotely controlled transmitter SOT. By activating the switching receiver SOR to switch the battery SOB, the audio becomes powered to transmit the desired animal or fowl call. Since the audio unit 50 power requirements are relatively low, a relatively small battery SOB and speaker 50S may be used to sound the desired call. Similar to the scenting unit 35, the audio unit 50 may be externally or internally attached to the body 3 and positioned so as to allow for the hunter to change calls as desired. The remote control SOT of the audio unit 50 allows the hunter to activate a desired call at a desired calling time. Accordingly turkey gobbles, bear, deer, elk, antelope, moose, safari wild life, etc. calls may be installed in the hardware of the decoy 1 and remotely activated as needed or desired by the hunter at the hunting site.

Although many of the Photographs and figures do not portray the actual desired decoy coloring to imitate the desired animal or fowl, the commercial versions for use by the hunters may be printed or otherwise colored to bare a coloring resemblance to the actual animals or fowl to be decoyed thereby.

| | |
|---|---|
| 1 | Decoy |
| 3 | Decoy body |
| 5 | Ambient air source |
| 7 | Ambient air pressure |
| 9 | D.C motor |
| 11 | Battery |
| 13 | Support member/brace |
| 15 | Air inlet |
| 17 | Air outlet |
| 19 | Remote switching member |
| 19R | Remote receiving unit |
| 198 | Remote sending unit |
| 21 | Torso |
| 23 | Leg appendages |
| 25 | Neck |
| 27 | Head section |
| 27E | Ears |
| 29 | Tail section |
| 35 | Scent emitting system |
| 31 | Orifices |
| 10 | Fan |
| 4 | Internal cavity |
| 6 | Tote bag |
| 40 | Valve |
| 35A | Sensors |
| 8 | Leg restraints |
| 16 | Air filter |
| 36 | Stakes |
| 38 | Pocket/sleeves |
| 50 | Audio unit |
| 50D | Sound source |
| 50S | Speakers |
| 50R | Switching receiver |
| SOT | Transmitter |
| SOB | Audio Battery |
| 42 | Accessing Port |

What is claimed is:

1. An inflatable and deflatable animal decoy for decoying use at a hunting site, said decoy comprising a body having an internal air confining chamber and legs for supporting the decoy in an upright inflated decoying position, a pressure source for providing pressurized air to inflate the decoy, a battery source for powering the pressure source and a switching member for switching the power source to inflate and deflate the decoy.

2. The decoy according to claim 1 wherein the pressure source comprises a motor driven fan powered by a battery.

3. The decoy according to claim 2 wherein the motor driven fan is operated at a decibel level of less than about 60 decibels.

4. The decoy according to claim 3 wherein the motor driven fan comprises a fan driven by a battery powered D.C motor.

5. The decoy according to claim 4 wherein the decoy includes a remote controlled switching member for remotely switching the battery powered D.C motor to inflate and deflate the decoy.

6. The decoy according to claim 5 wherein the decoy includes a lithium battery for powering the D.C motor.

7. The decoy according to claim 2 wherein the body provides an internally air retaining compartment within said body, with said body having a torso, four legs, an animal head supported by a neck and an oppositely positioned tail, with said body being constructed of a material sufficiently pliable so as to permit stowing of the deflated decoy in a tote hag of a substantially smaller size than the inflated decoy.

8. The decoy according to claim 7 wherein the decoy measures at least three feet in height and at least three feet in length, weighs less than 10 pounds and may be stowed in a tote bag having a stowing capacity of less than 20 percent of the volume of the inflated decoy.

9. The decoy according to claim 4 wherein decoy is a deer decoy and the body includes four legs, a head supported by a neck and a tail, one of the four legs serves as an air intake for the pressurized air and at least two legs distal to the air intake include supportive bracing to assist in maintaining the two legs in an upright standing position and the decoy when deflated may be stowed in a tote bag having a volume capacity of less than ten percent of an inflated volume of the decoy.

10. The decoy according to claim 2 wherein the body includes seamed sections sewn together to provide a deer decoy when inflated to the decoying position and the decoy includes a prey attractant scent disseminating unit for dispensing the scent along with the pressurized air into the chamber with said body having sufficient air seepage from said body to allow for the scent to disperse about the hunting site while still retaining sufficient pressurized air within the chamber to retain the decoy in the standing position.

11. The deer decoy according to claim 10 wherein the decoy includes stake retaining members for staking the inflated decoy to a grounded base at the hunting site.

12. A method for deploying an inflatable animal decoy at a hunting site, said method comprising:
A. providing an inflatable and deflatable animal decoy comprising a flexible body having an internal air confining chamber, legs for supporting the decoy in an upright, inflated decoying position, a pressure source for providing pressurized air to inflate the decoy, a battery source for powering the pressure source and a switching member for switching the power source to inflate decoy at a hunting site and to deflate the decoy
B. transporting the deflated decoy to a hunting site and
C. switching the power source to inflate the decoy to the inflated decoy.

13. The method according to claim 12 wherein the providing of the pressure source comprises a motor driven fan powered by a battery.

14. The method according to claim 13 wherein the providing includes a motor driven fan operationally maintained at a decibel level of less than about 50 decibel at the inflation position.

15. The method according to claim 14 in the providing includes the fan driven by a D.C battery powered motor.

16. The method according to claim 15 wherein the providing of the decoy includes a remote controlled switching member for remotely switching the D.C battery powered motor to an inflating position and switching the motor off to deflate the decoy.

17. The method according to claim 15 wherein the providing of the decoy includes a lithium battery for powering the D.C motor.

18. The method according to claim 17 wherein the method includes the additional steps to deflating the decoy and transporting the deflated decoy from the hunting site.

19. The method according to claim 13 wherein the providing includes a prey scent disseminating attachment containing a prey attractant operationally connected to the pressure source for release with the pressurized air into the chamber and the body includes sufficient porosity to allow for a seepage therethrough to provide a prey scented hunting site.

20. The method according to claim 17 wherein the providing of the body includes a torso, four legs, an animal head supported by neck communicating within an internal air retaining compartment and a tail with at least one of said legs having a restricted air passageway internally positioned within at least one of the legs in junction to the torso, with said restricted passageway being further characterized as providing a sufficient air passageway restriction to allow at least one leg to inflate to standing position before inflating the torso to the fully inflated decoying position.

21. The method according to claim 20 wherein the providing includes the providing of a deer decoy measuring from about 3 to about 6 feet in height, about 3 to about 6 feet in length, a total deflated decoy weight of less than 4 pounds excluding battery weight and the body of the deer decoy is constructed of a pliable material so as to permit the deflated decoy to be compacted together to provide a stowable and transportable deer decoy when deflated.
